(19) United States
(12) Patent Application Publication
(10) Pub. No.: US 2005/0216949 A1
(43) Pub. Date: Sep. 29, 2005

(54) Systems and methods for a universal media server with integrated networking and telephony

(76) Inventors: Ray Candelora, Colts Neck, NJ (US); Joseph Gerard Aguilar, Oak Lawn, IL (US); Dale Louis Skran, Marlboro, NJ (US)

Correspondence Address: Dale L. Skran, 85 Ottowa Road South, Marlboro, NJ, 07746, US

(21) Appl. No.: 11/087,204

(22) Filed: Mar. 23, 2005

Related U.S. Application Data
(60) Provisional application No. 60/555,552, filed on Mar. 23, 2004.

(51) Int. Cl. H04N 7/173; H04L 12/66; H04N 7/16

(52) U.S. Cl. 725/134; 725/142; 725/89

(57) ABSTRACT

Systems and methods for creating a Universal Media Server (UMS) and associated Digital Media Renders (DMRs) are disclosed. This system provides functions such as in-home wired or wireless network for media distribution with PVR functions from a distributed archive while at the same time including functions such as an answering machine, voice recorder, voice over IP gateway, firewall, NAT, DHCP, and security monitoring. A variety of advanced features and functions are also disclosed.

This application claims priority of provisional application Ser. No. 60/555,552, filed on Mar. 23, 2004, which is incorporated herein by reference.

### FIELD OF INVENTION

The present invention relates to the problem of in-home distribution of media (music, video, still images) where a centralized device, usually called a media server, acts as an archive, and one or more Digital Media Receivers (DMRs) are distributed throughout the home and connected via a wired or wireless network. The invention also relates to the field of home data networking and telephony services as the functions of data networking and telephony are integrated with the media server as a basis for the invention. The preferred embodiment of such an integrated media server/networking/telephony system supports a variety of advanced features including but not limited to a new type of speech recognizing remote control, seamless management of multi-media storage redundancy, advanced media on-hold telephony features, and the integration of security cameras inputs with entertainment programs for rapid alerting of problem conditions.

### BACKGROUND OF INVENTION

One current approach to in-home media distribution is a centralized media server connected to one or more DMRs placed in different locations in the home. These DMRs connect directly to televisions or stereo equipment so that the media delivered to the home over the Internet is presented to the user in various rooms of the home. Typically media servers provide personal video recorder (PVR) services. Often media servers may be connected to cable set top boxes, satellite set-top boxes, or to television antennas to support the reception of video signals. In some available equipment the DMR function may be embedded in equipment such as televisions or digital video disk (DVD) players. These systems are typically controlled via the interactions of an infra-red (IR) remote control with each DMR. Certain additional devices are essential to the operation of the above network, including a broadband modem (typically cable or digital subscriber line (DSL) and a router. The router often provides functions such as a firewall, network address translation (NAT), and dynamic host configuration protocol (DHCP). Sometimes a wireless access point (WAP) is also part of the network. Other functions typically performed in a home include the reception of telephone calls, the storage of incoming telephone calls in a separate answering machine, and the recording of voice calls as needed, which typically requires a separate analog or digital recording device. In response to the development of the type of media server products just described, cable service providers are providing cable set top boxes with integrated PVR and telephony features.

Current equipment for in-home media distribution suffers from a variety of difficulties, including but not limited to (1) the end-user is required to set up and manage a large number of in-home networking devices, including a router, firewall, NAT, DHCP server, and WAP, (2) the “media server” is often a PC, and suffers from various sources of unreliability, including but not limited, to untested software interactions and viruses, (3) equipment (PVRs, PCs) is typically purchased with hard disk drives (HDDs) of a certain size, which rapidly become obsolete, causing the customer to upgrade the HDDs at some risk of damaging the equipment they have invested in, and resulting in the loss of the value of the older HDDs, (4) redundant disk storage is rarely provided, and if it is, this capability is not integrated with the media storage function in a logical, seamless, and automatic fashion, (5) there exist many devices, often each with its own remote control, causing confusion to the user, and (6) this entire list of equipment is relatively expensive and has many redundant components, including but not limited, to power supplies, processors, memories, and chassis.

Various prior art references relate to networking features of home media servers and gateways. For example, attention is called to the “AboCom MultiMedia Gateway” as described in a brochure distributed at the January 2004 CES show, incorporated herein by reference for additional background. This device combines PVR functions with a WAP and routing/NAT/DHCP. However, this prior art does not include telephony functions, an answering machine/voice recorder, speech recognition, advanced DMRs, or seamless storage management. U.S. patent application No. A20040003073 describes a very general remote control that, via a central server, can control almost any device located in the home. The main unique area of U.S. patent application No. A20040003073 deals with location-based services and controllers with location self-identification. It also describes a bridge between wireless control messages and the infra-red control expected by legacy consumer electronics devices. A WAP combined with internet access combined with storage combined with a controller is described. Although the focus is on remote control of various entities, mention is sometimes made that they could be part of the controller. There is also mention of storage both inside and outside the controller. However, U.S. patent application No. A20040003073 does not include telephony functions, an answering machine/voice recorder, speech recognition, advanced DMRs, or seamless storage management. U.S. patent application No. A20030217110 describes a home gateway which includes functions such as a firewall, router, wireless access point, a telephone answering machine, and a voice over internet protocol (VoIP) gateway. However, U.S. patent application No. A20030217110 does not include entertainment functions, a voice recorder, speech recognition, advanced or other DMRs, or seamless storage management.

Another type of prior art disclosure relates to the integration of telephone answering machines with various types of equipment. U.S. patent application No. A20030028900 deals only with the addition of an answering machine function to a set-top box for the purpose of remotely programming the set-top box to record video programs. This type of equipment cannot provide full integration of the answering machine with a rich media environment as does the embodiment described in this application. U.S. patent application No. A20030043260 describes a set-top box which provides both PVR and answering machine functionality. This prior art device does not provide the large, multi-location, seamlessly managed redundant data base needed to ensure the preservation of important messages.

A variety of disclosures relate to enhancements to PVR systems. U.S. patent application No. A20020114613 describes various video editing capabilities in a PVR-type device. However, the advanced media editing capabilities of U.S. patent application Ser. No. ______ “Systems and Method for Enhanced Video and Audio Program Editing”, Skran, et al., Feb. 22, 2005, which is incorporated herein by reference, and which are part of the embodiment, advance beyond those of U.S. patent application No. A20020114613 in adding new functions such as SKIP-DELETE and extending the editing capabilities to audio as well as video. U.S. patent application No. A20020102092 describes passing a video signal through the PVR to a connected TV. This narrow application does not address the combination of PVR, networking, and telephony functions. U.S. patent application No. A20030215211 describes a “PC-based PVR.” This patent is not relevant as the system described here does not require PVR functions to be located in a standard PC. In addition, U.S. patent application No. A20030215211 is focused narrowly on the PVR function alone. U.S. patent application No. A20030214957 describes a set-top box with PVR functions that uses encryption-protected external storage of digital media to provide a pay-per-access service. Such prior art systems do not provide seamless management of HDDs in various locations and of varying sizes.

A further area of disclosure relates to the integration of telephony functions with home media servers and gateways. U.S. patent application No. A20030086432 describes the management of incoming telephone calls using a television screen, but this prior art system does not provide for customized, media-rich interactions with incoming telephone calls.

The integration of advanced remote controllers with media servers and gateways constitutes another area of disclosure. U.S. patent application No. A20020059637 envisions an advanced remote controller of a set-top box, which may include a VoIP telephone, a PVR controller, a web browser, etc. This prior art system does not allow the remote control to be used to control arbitrary PC applications using text entry via the remote or using speech recognition. U.S. patent application No. A20040003073 discloses a wireless remote controller that is location-aware, and is able to control all the devices in the home. However, this prior art solution addresses only one of the problems described above, and also brings with it a new set of problems, for example, the difficulty of using the new wireless remote to manage a number of devices in each room.

Other disclosures are also referenced. U.S. Pat. No. 5,675,390 describes an entertainment center that is a combination of a TV screen without a tuner, and tuner equipped PC. This prior art system associates the TV closely with the media server, such that television programming is limited to a single location in the home. U.S. patent application No. A20030226149 describes a system whereby a single access line brings both HDTV video and internet access to the home, and then distributes HDTV within the home via Institute of Electrical and Electronic Engineers (IEEE) 1394 so-called “Firewire”. This prior art equipment is limited by the usage of a particular type of physical wire and protocol, and addresses only the distribution of TV signals.

It is also noted that a variety of speech recognizing remote controls are currently available. In such current systems, the work of speech recognition is done in the remote itself, limiting their capabilities. This approach requires that all of the work related to speech recognition be done in a battery powered remote with limited processor capacity. As a result, the quality of speech recognition provided by such systems will be limited.

Accordingly, there is a need to develop a system and method for better integrating the functions of in-home media distribution and access, media storage, telephony, and networking, and hence providing enhanced functionality as a result of this integration, examples of such integration were discussed above, associated with the prior art.

### SUMMARY OF INVENTION

The application relates to a system comprising a centralized media server, hence to be called the UMS (Universal Media Server) and one or more DMRs. The UMS and the DMRs are connected by a digital network of any type, wired or wireless, including power wires, but most typically, and to be preferred, is an IEEE 802.11 b/a/g wireless network supporting the internet protocol (IP) protocol suite. Although targeted to the home, such a system might be used anywhere, such as at a hotel or in a small office or business.

The UMS includes the following modules or functions: Telephony/VoIP, Networking, Storage, and Entertainment. The networking module connects the public Internet with the home network. Note that the UMS connects to the Internet via some kind of data modem, such as for example a DSL modem, or a connection to a cable modem that might be part of the cable TV set top box. This connection could also be via any other kind of modem, including a fixed wireless modem, a cellular modem, etc.

The telephony/VoIP module allows either or both legacy Public Switched Telephone Network (PSTN) phones and VoIP phones in the home to connect to VoIP service providers on the Internet. The telephone/VoIP module may also provide protocol support for videophone calls. The telephony/VoIP module shares the connection to the Internet with the entertainment module.

The storage module allows media to be stored internally to the UMS, via a disk attached directly to the UMS, via networking in the home, or remotely over the Internet. Media may be received over the internet and saved for later usage in the storage module.

The entertainment module allows for the compression and time-warping of incoming video streams from a cable or satellite TV box, and supports the distribution of the time-warped and processed media to DMRs throughout the home, where it is displayed on televisions or monitors. In some embodiments, the entertainment module may collect media from additional sources, or distribute processed media to directly attached equipment such as a television. The Internet can also be a source of media that may be distributed to the DMRs either directly or via the entertainment module. The media distributed may be in any digital format, including but not limited to high definition television (HDTV).

In embodiments of the UMS system with all of the modules just described above, in-home network bandwidth is saved in four specific ways relative to systems where the modules are located in separate devices.

In an embodiment with multiple sizes of HDDs, some internal to the UMS, some external to the UMS, some networked in the home, and some external to the home, the invention provides for (1) a flexible assignment of media to priority levels, (2) a flexible assignment of redundancy capabilities to priority levels, (3) the ability to automatically spread redundant data over disks of varying sizes, (4) the ability to automatically incorporate a new HDD into the system, and (5) the ability to automatically re-allocate data when a HDD fails.

In a particular embodiment the user can set the redundancy level of media being stored via an on-screen menu or a button on the IR controller. This might be used to mark a television show being watched for permanent, reliable retention.

In another embodiment of the UMS, a capability is provided to pass the incoming analog video signal through to a locally attached television, thus allowing the user to watch television on one channel while the UMS is recording on another channel at the same time.

In an embodiment providing for answering machine/voice mail functions, the UMS supports the following relative to prior art answering machines and PVRs: (1) the ability to store many thousands of voice messages, (2) the ability to specify long-term, redundant storage of important voice messages, (3) individualized response to incoming callers with much larger set of greetings and responses, including, for example, playing someone's favorite song while they are on hold, and (4) the ability to retrieve messages from any room in the home equipped with a DMR and IR remote.

In an embodiment providing telephony features such as hold, music on hold and video on hold can be provided using the large media database that is available in the UMS.

In a particular embodiment a “do not disturb feature” causes incoming telephone calls to automatically go to an answering machine while a picture of the caller is displayed in a picture in picture (PIP) window on the TV screen, allowing the viewer the opportunity to take the call.

In an enhanced embodiment with a security module in the UMS the automatic creation of PIP windows taken from the security cameras based on the detection of motion is provided, with the PIP window appearing on all active DMRs or a subset thereof. The video feed from such security cameras, which may be attached to enhanced DMRs described below, may also be introduced into videophone calls based on sensed motion as well as via other criteria.

In another embodiment containing the video editing technology found in U.S. patent application Ser. No. ______ “Systems and Method for Enhanced Video and Audio Program Editing”, Skran, et al., Feb. 22, 2005, incorporated here by reference, thumbnail surfing using category/genre is provided.

In some embodiments enhanced DMR capabilities include: (1) an interface to a telephone allowing the DMR to function as a VoIP gateway, (2) an interface to data devices, making the DMR a wireless hub, and (3) an interface to a USB2.0 (or other) camera and internal microphone/speaker allowing the DMR to become a videophone.

In a preferred embodiment, the UMS/DMR system includes the capabilities described in U.S. patent application Ser. No. ______ “Application Interface Streaming System and Method”, Aguilar, Feb. 28, 2005, which is incorporated herein by reference. In this preferred system, the enhanced UMS/DMR system provides capabilities including (1) allowing a DMR/display unit combination to be used as a wireless browser or game station display, (2) access via a DMR/display unit combination to arbitrary computer applications, and (3) videophones/telephones that provide full functionality at less cost since the more expensive operations are performed in the UMS rather than the DMR.

In a preferred embodiment of an enhanced remote control, the remote control device collects speech input and sends it to the UMS via its associated DMR, where this speech is analyzed and converted to commands or other program inputs, allowing the end-user to control arbitrary computer applications without a keyboard while watching television. The preferred embodiment of the UMS also provides a system and method which allows for suddenly “active” video channels to appear in a PIP, interrupting another video that is currently being viewed. This application applies to both entertainment video streams and security camera video streams, and also to video streams containing images generated by arbitrary PC or media server applications.

In conclusion, a system and method is disclosed for a digital media recorder comprising an input for receiving media streams, at least two storage devices for storing the received media streams, a processor for providing redundant storage of the received files in the storage devices, an output for connecting to a device capable of rendering the media files; and means for specifying user preferences for storing the received media streams in the storage devices.

### BRIEF DESCRIPTION OF THE DRAWINGS

The present invention may be understood more fully by reference to the following detailed descriptions of the embodiments and the appended figures in which:

FIG. 1 illustrates a high-level view of the UMS/DMR system.

FIG. 2 illustrates the internal components of the networking module.

FIG. 3 illustrates the internal components of the entertainment module.

FIG. 4 illustrates the algorithms used in the media redundancy strategy.

FIG. 5 illustrates the internal components of telephony/VoIP module.

FIG. 6 illustrates how speech recognition and caller id can be used to customize the response to incoming telephone calls that are not answered.

FIG. 7 illustrates how the UMS/DMR system can be expanded to provide a security monitoring function.

FIG. 8 illustrates various ways DMRs can be enhanced to provide advanced VoIP, video telephony, and data networking features.

FIG. 9 illustrates the exterior physical design and preferred dimensions of a speech recognizing remote control.

FIG. 10 illustrates the block diagram for the electrical design of a speech recognizing remote control.

### DETAILED DESCRIPTION OF THE PREFERRED EMBODIMENTS

The present application relates to an enhanced media server referred to as the UMS. For purposes of illustration only, the following discussion is presented in the context of a system comprising of a UMS and one or more DMRs, each physically attached to an associated television set, and each DMR being controlled via an IR remote control. Feedback to the user in response to actions with the remote control is via on-screen messages displayed by the television. It should however be understood that this is not intended as a limitation, and that various other embodiments are possible, as described below.

In particular, the type of controller which is utilized, which if remote, may be an IR controller, a wireless controller, a wired controller, etc. or if not remote, may be a set of buttons that are part of the DMR or the UMS device. The usage of speech recognition to input information via the remote control device is also part of the invention. In various embodiments of the invention, feedback related to the status of actions may be provided to the user via visual, auditory, or other means. Any of a variety of media may be involved, which may include audio, video plus audio, or a sequence of images and associated optional music. In various embodiments, the in-home network, may be wired rather than wireless, and if wired, may utilize either special purpose cables or existing power wires. Without regard to the physical nature of the network, any of a variety of digital networking protocols might be used, including TCP/IP. Various optional components and functions are described as being part of the preferred embodiment of the invention. In some embodiments the DMR function may be embedded in devices such as televisions, DVD players, VCRs, etc. Monitors or televisions may be directly attached to the UMS in addition to or instead of being attached to the DMRs.

The preferred UMS embodiment has the following characteristics, which although preferred are not critical nor do they define the invention. The preferred UMS has no keyboard or attached monitor, and is dedicated to the purpose of being a media server. In the preferred embodiment, the operating system is Linux, but another OS such as Microsoft Windows™ might be used. The preferred UMS is a “sealed” device, with the user having no ability to load games or other applications; only manufacturer approved software upgrades are allowed. The usage of an open, standard PC as the UMS, although not preferred, is part of the invention.

In the preferred embodiment a web-based management system allows for updating program recording instructions from any web terminal in the world, including one on a cell phone, or from any PC in the home running a standard browser. All management functions that are accomplished via the DMR associated IR controller may also potentially be accomplished via the web-based management system, and the reverse. The decision to not provide some or all of these means does not affect the essence of the invention.

Those of skill in the art will appreciate that the above description of the preferred embodiments is for illustration purposes only, and is not limiting on the scope of the invention, which is defined below.

The UMS comprises a general purpose processor, the software running on it, and a variety of additional hardware modules and interfaces. Whatever operating system is used needs to have interrupt capability to allow for the handling of real-time operations such as media stream management; this capability exists in all of the operating systems mentioned above.

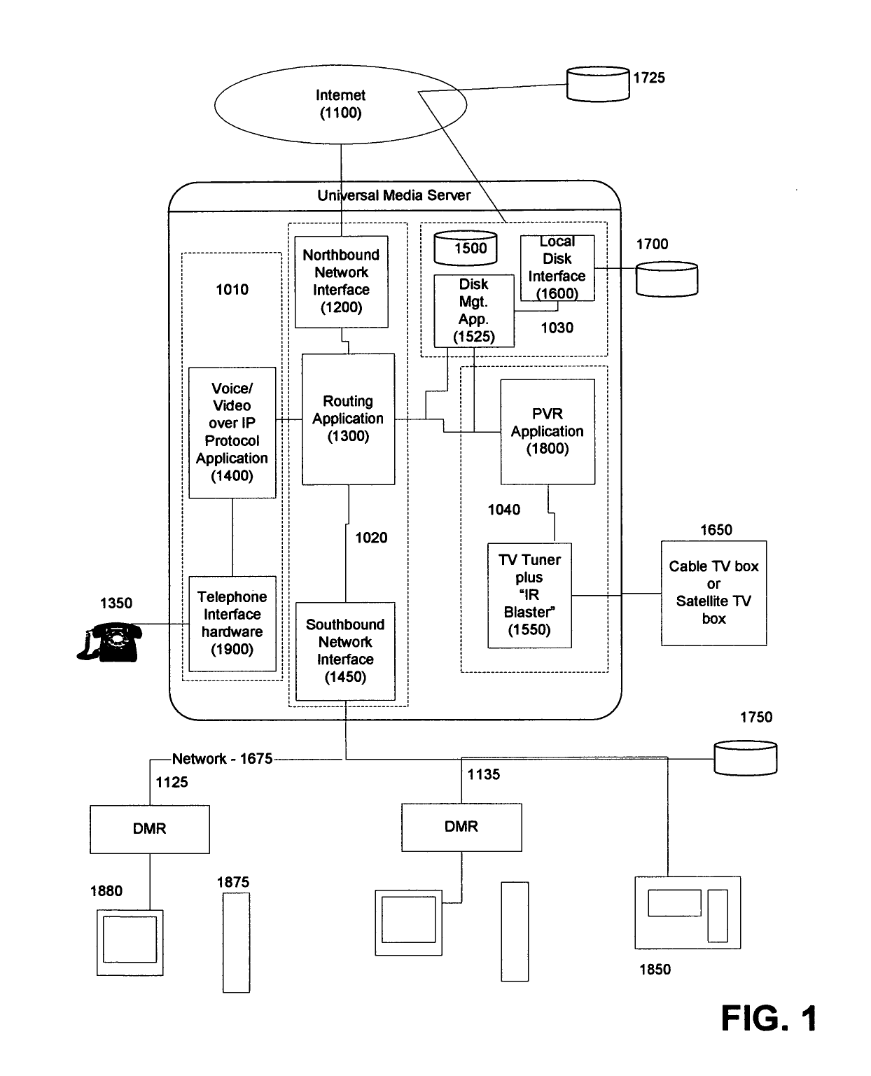

FIG. 1 illustrates the preferred embodiment of the DMR/UMS system. A northbound network interface 1200 supports connection to the Internet 1100. Interface 1200 is a 10/100/1000 Mbps Ethernet interface, although any other digital connection to the internet might be used instead without changing the invention. The UMS minimally performs a packet routing function 1300, which is bi-directional and may implement one or more routing protocols well known to those skilled in the art such as routing information protocol (RIP), RIP2, border gateway control protocol (BGCP), etc. or instead may act as a simple data switch. The routing module 1300 connects various applications such as VoIP protocol 1400, and PVR 1800, as well as connecting the northbound network interface 1200 with the southbound network interface 1450. Note that if the in-home network 1675 is wireless, 1450 performs WAP functions. Standard analog telephones 1350 are connected via RJ-11 interfaces to standard telephone interface hardware 1900, which supplies raw audio and telephony signaling to the VoIP protocol application 1400. In addition to implementing a standard VoIP protocol such as session initiation protocol (SIP), H.323, media gateway control protocol (MGCP), etc., module 1400 may transcode the raw audio to a compressed audio form such as, for example, G.711, G.728, G.729, G.723.1, etc. The UMS is also capable of supporting telephones 1850 that implement standard VoIP protocols such as SIP, H.323, MGCP, etc. In this case the VoIP protocol application may perform a proxy function to convert local signaling (for example, MGCP) to network signaling (for example, SIP). The PVR application 1800 takes video signals from the TV tuner 1550 and compresses them using a video protocol such as for example motion picture experts group two (MPEG2), MPEG4, H.264, etc. Typically the compressed video signals are then stored on one or more of disks 1500, 1700, 1725 and 1750. Disk 1500 is a HDD that is part of the UMS. Disk 1700 is connected via the local disk interface 1600 to the UMS. The local disk interface 1600 is in the preferred embodiment one or more universal serial bus (USB) 2.0 ports, but could be ethernet, or another standard data interface. Disk 1750 is a networked disk that can be reached only over the in-home network 1675. Disk 1725 is remoted over the internet 1100, and might be provided by a commercial data backup service. The disk management application 1525 coordinates the disks to provide for media storage redundancy. The TV tuner/“TR Blaster” 1550 is responsible for interfacing to a video source 1650 such as a cable set-top box or satellite TV box. This device 1550 uses IR well-known to those skilled in the art to change channels on the video source device 1650. On request from IR remote 1875 associated with a DMR 1125, the PVR application retrieves compressed video from the disk management application 1525 and sends it to the DMR 1125 via the routing application 1300 and the southbound network interface 1450. DMR 1125 and IR remote 1875 can be used to signal the PVR application 1800 to perform “trick mode” features such as PAUSE for either live or stored television.

In the preferred embodiment the UMS must be constructed in such a fashion that the routing application 1300 can switch multiple media streams between the northbound interface 1200, the telephony/VoIP module 1010, the southbound network interface 1450, the storage module 1030, and the entertainment module 1040. This requires an internal bus well known to those skilled in the art such as a peripheral component interconnect (PCI) bus, cell-bus, etc. or other high-speed bus capable of switching multiple 6 million bits per second video streams. The northbound interface 1200 must have sufficient bandwidth to allow access to media being downloaded from the Internet 1100, or for transfer of media to the remote disk 1725 for backup. This can be accomplished using standard 100 Mbs ethernet hardware connected to various broadband modems such as DSL modems, cable modems, fixed wireless modems, cellular modems, or other such standard devices. The southbound interface 1450 must have sufficient capacity to allow for the distribution of multiple media streams to various DMRs, while possibly retrieving some material from a local networked disk 1750. This can be achieved by the use of a 100 Mbps Ethernet interface, or by the use of an IEEE 802.11 a/g wireless access point interface supporting 54 Mbps. These are the minimal values; an alternate implementation would use gigabit Ethernet or Ultra-Wideband Wireless (UWB).

In the preferred embodiment the routing application 1300 must give priority to packets associated with telephony applications 1010 over those associated with the entertainment application 1040, otherwise the users of the telephony features will experience call degrading delays. Real-time video-telephone images are given a higher priority than entertainment video, but lower than the audio associated with real-time telephone or videophone connections.

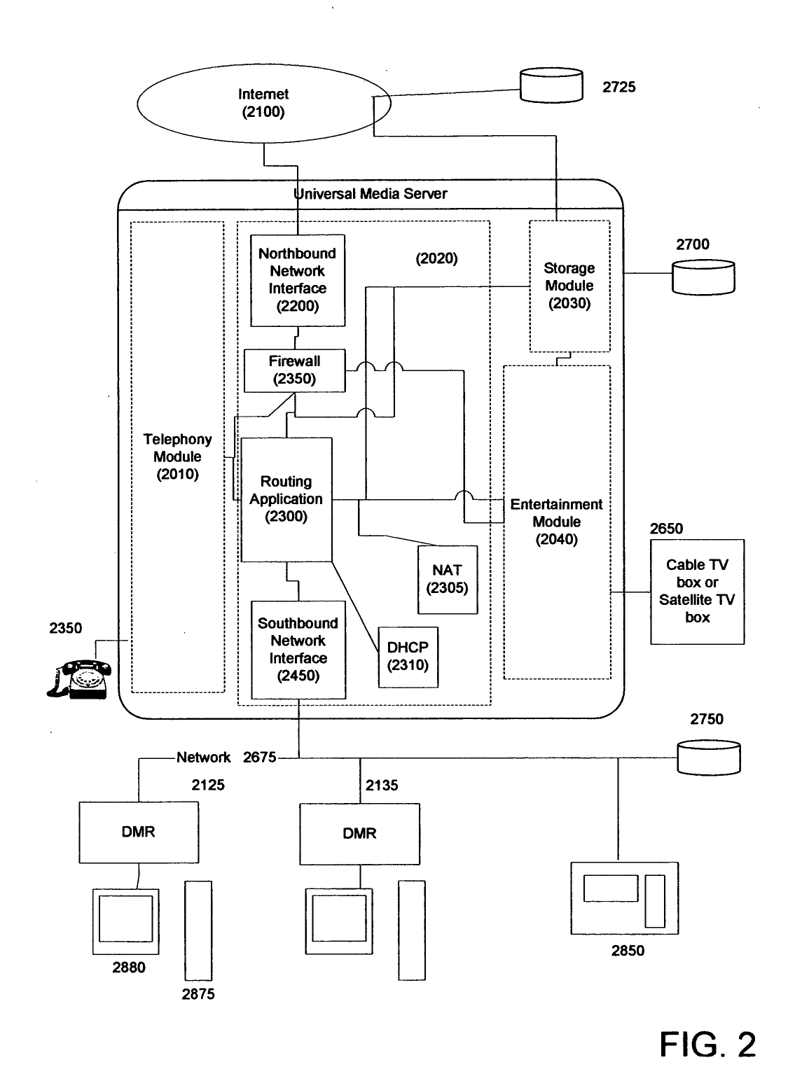

The routing application 1300, which may include a firewall 2350 as illustrated in FIG. 2, must be media aware, as must the firewall, if present. This means that the device must be aware of incoming media downloads or VoIP calls, and must have the capability of “tunneling” the path the media takes to avoid packet-by-packet examination of the high-volume media packets. FIG. 2 illustrates how several standard data protocols could be added to the UMS. A firewall 2350 is added between the north bound network work interface 2200 and the routing application 2300. On a peer level with the routing application 1300, standard functions such as DHCP 2310 and NAT 2305 may be provided. A firewall is a standard function which can be variously implemented by those skilled in the art but serves to protect the home against unwanted intrusions from the Internet. NAT 2305 allows IP addresses in the home to share a single, externally visible IP address. DHCP 2310 allows DMRs or other in-home IP devices to receive IP addresses automatically when they are turned on, easing setup and installation of the entire system. Both NAT and DHCP are essential to an easy-to-use home network, and are thus part of the preferred embodiment.

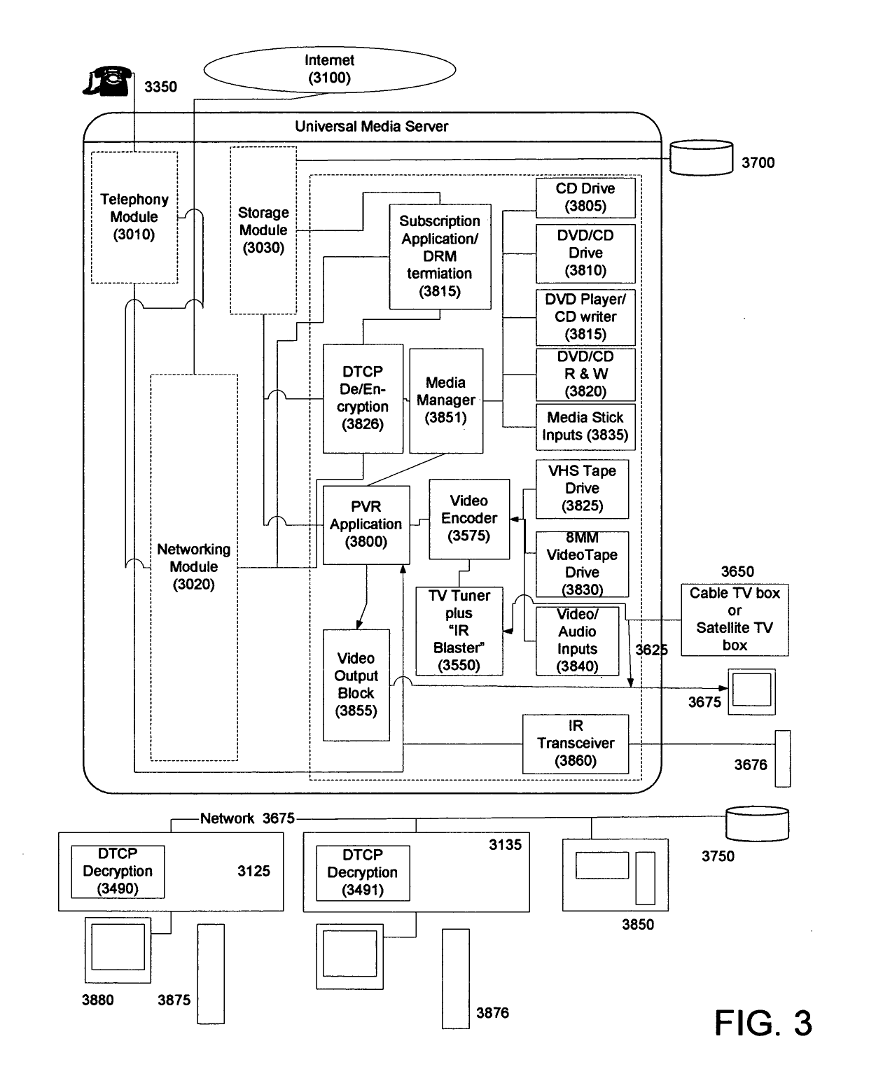

In the preferred embodiment, the firewall is made aware of the presence of telephony or videophone devices in the home via signaling from the VoIP protocol application 1400 in FIG. 1, which requests “holes” be opened in the firewall for outgoing calls. The firewall is also watching for incoming calls on the standard IP addresses being used by the various VoIP protocols. The specific purpose for making the firewall protocol aware is to allow it to avoid having to examine all incoming media packets one by one. Second, the firewall is made aware of incoming media file transfers or streams by the subscription application 3815 illustrated in FIG. 3. This application 3815 is responsible for establishing a relationship with a media subscription service, and then informing the firewall 2350 and/or the routing application 2300 that “holes” are to be opened for the incoming media.

The preferred embodiment of the UMS as described above can be readily constructed by those skilled in the art. This preferred embodiment, as a result of having the specific characteristics just described provides a number of enhanced benefits over existing equipment. In particular, and referring to FIG. 2, the media aware routing module 2300 and/or firewall 2350 will directly route media from the Internet 2100 (after appropriate initial processing by the entertainment module 2040) to the storage module 2030. If the router/firewall were in a separate unit from the entertainment/storage modules, as is typical in the state of the art, this media stream would take up bandwidth on the local home network 2675, but in the embodiment this transfer is internal to the UMS, and the bandwidth on the local home network is available for other uses.

Again referring to FIG. 2, the entertainment module 2040 will directly route media from a “set-top box” 2650 (after appropriate processing, including compression using MPEG2, etc.) to the storage module 2030. Because the embodiment comprises not just of a stand-alone PVR, but of a UMS/DMR system, the direct routing of the media internally has the additional benefit of saving bandwidth on the internal home network 2675 which can be used for other purposes.

With reference to FIG. 2, the same type of advantage can be discerned, but resulting from another source. The media aware routing module 2300 and/or firewall 2350 will directly route voice calls from the Internet 2100 (after appropriate initial processing by the telephony/VoIP module 2010) to the storage module 2030. If the router/firewall were in a separate box, as is typical in the state of the art, this voice stream would take up bandwidth on the local home network 2675, but in this embodiment this transfer is internal to the UMS, and the bandwidth on the local home network is available for other uses.

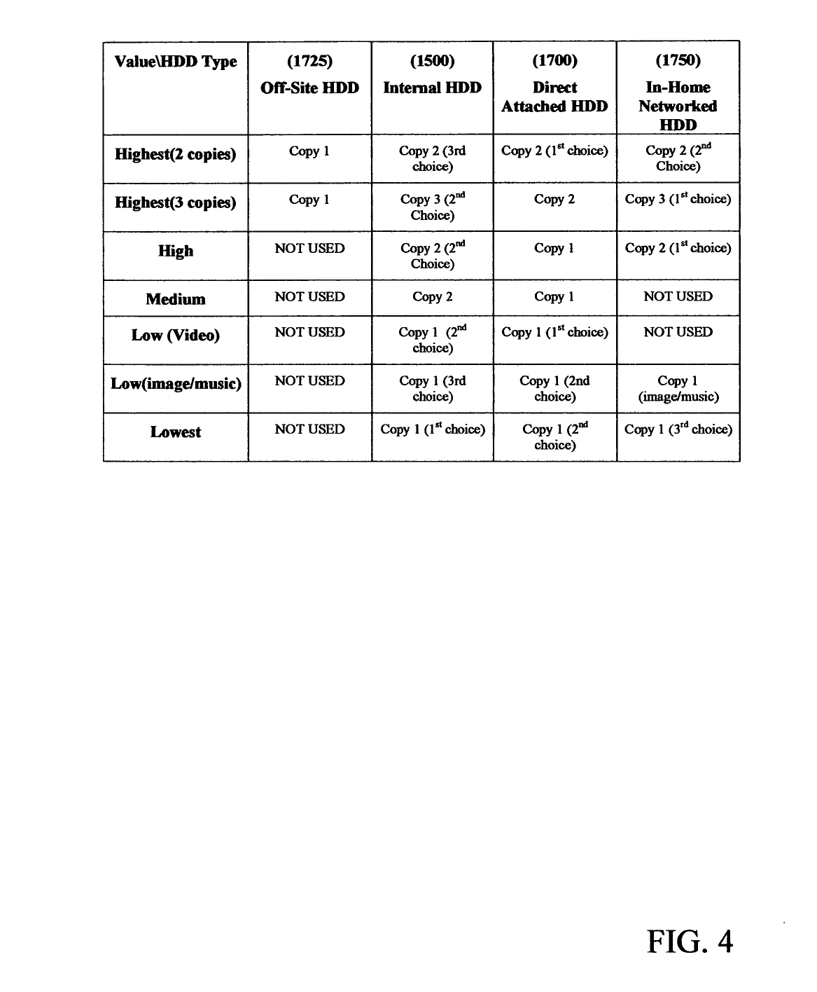

A particular aspect of the preferred embodiment illustrated in FIG. 1 is that the storage for modules 1010, 1020, and 1040 is unified in 1030. If 1030 contains multiple disks internal or external the storage module presents them to the applications 1010, 1020, and 1040 as a single storage volume. The Disk Management Application 1525 provides for the separation of the various media files into different categories which are stored in various disk locations, assuming the relevant disk is present in a given embodiment. This separation into categories is performed automatically by the UMS entertainment module 1030 as media items are created, recorded, or saved. The DMR user interface that appears on the TV 1880 or other control interface allows for manual over-ride of the default category with a user preferred value. The preferred categories and treatments for different redundancy priorities are described below, and are also illustrated in FIG. 4.

The items of highest value, comprising, for example, personal photographs of great value such as wedding pictures, etc. are stored as a default both locally in 1500, 1700, or 1750 and outside the home 1725, providing for geographical redundancy as well as in-home redundancy. In one particular embodiment, a third copy of the highest value material, such that the material is stored redundantly locally in 1500, 1700, and 1750 and in addition a third copy is kept outside the home in 1725 as well.

Items of high value comprising, for example, other personal photographs and purchased music as a default are stored redundantly in 1500, 1700, and/or 1750.

Items of medium value comprising, for example, videos that the user has paid for, such videos generally being quite large compared to purchased music, are, as a default, stored redundantly on 1700 and 1500. Disk 1750 is not used so as to minimize the utilization of bandwidth on 1675.

Items of low value, including, for example, media material from various sources, where music and images are stored non-redundantly in 1750 and videos non-redundantly in 1700 due to their larger size.

Items of lowest value, including, for example, TV shows or music recorded for one-time usage, as a default, are stored non-redundantly in 1500. In a particular embodiment, when disk 1500 is filled, available space on disks 1700 and then disks 1750 are used for additional space in that respective order.

In the preferred embodiment the categories and associated treatments are stored in an editable text file. Many other implementations are possible which the sophisticated user may update as desired to change the default storage locations for a given media type. In a particular embodiment an enhancement to the PVR user interface allows the user to increase the redundancy level of media being stored via an on-screen menu or a new button on the IR controller. This might be used to mark a television show being watched for permanent, reliable retention. As part of the PVR recording setup, redundant storage can be specified as a default for particular high-value television programs.

Redundancy can be implemented via a variety of techniques well known to those skilled in the art, such as redundant arrays of independent disks (RAID) 0, RAID1, RAID5, etc. However, the preferred approach is simple one-for-one redundancy, i.e. keeping an additional complete copy (RAID1). Although a commercial database such as ORACLE, Microsoft ACCESS, etc. can be run as part of the storage module 1030, this type of technology is not essential to the UMS and is not preferred, as it adds additional cost, management complexity, and functions that are not required for this application.

In the preferred embodiment the UMS is aware of the type of media being stored, i.e. audio, video, and/or image as well as the local disk configuration, allowing it to automatically distribute media in a default fashion according to certain rules without user intervention as illustrated in FIG. 4. If a single disk of each type 1500, 1700, 1725, and 1750 exists, the table illustrated in FIG. 4 is used to determine the location the redundant media. Note that multiple disks may exist of each type 1500, 1700, 1725, and 1750. If this is the case, the steps below are used to determine where to keep Copy 2 and Copy 3:

STEP ONE: Select a priority level from the leftmost column of the table illustrated in FIG. 4.

STEP TWO: Select the location of Copy 1 as indicated by FIG. 4, i.e. one of the types of disks 1500, 1700, 1725, and 1750.

STEP THREE: If there exists in the combined UMS/DMR system only a single disk of the type designated for Copy 1, use this disk for copy 1, and then use the table in FIG. 4 to select the location of Copy 2. If the Copy 2 disk is larger than the Copy 1 disk, or if there are multiple instances of the Copy 2 disk, then the amount of space that can be allocated for Copy 2 material of this priority level is limited to the amount of space allocated for Copy 1 on single disk being used for this priority level.

STEP FOUR: If there exists in the combined UMS/DMR system multiple disks of the type designated for Copy 1, select the largest of these disks for Copy 1. Without regard to the directions of the table in FIG. 4 for the location for Copy 2, designate the non-Copy 1 disks of this type for Copy 2. If this does not provide sufficient space for Copy 2, select an additional disk or disks for Copy 2 as suggested by the table illustrated in FIG. 4. If there is sufficient space for Copy 2, move on to Copy 3. If there is insufficient space for Copy 2, reduce the space allocated for Copy 1 until it matches the space available for Copy 2.

STEP FIVE: Apply the same rules for Copy 3 if the table in FIG. 3 suggests a third copy is needed.

In the preferred embodiment, when a new disk of a particular type is added to the system, and the UMS becomes aware of this disk via a variety of standard protocols such as universal plug and play (UPnP) well known to those skilled in the art, the UMS re-runs the steps just described above for each priority level of media, taking into account the new disk, and moving data as needed to make proper use of the new disks. The specific advantage of this preferred embodiment is that once the user has designated a set of preferred storage locations for various media priority levels, and also has designated the priority level of specific media items to be stored, the UMS will automatically adapt to the addition of disk space without further intervention.

In the preferred embodiment space can be “double used,” that is, allocated to more than one priority level. Depending exactly on what is actually stored, the full amount of space is available for each purpose until a conflict arises. This allows for the maximum flexibility in usage. When conflicts occur, on-screen messages appear on television 1880 which suggest a course of action, i.e. “Clean up Medium Priority Videos,” that will resolve the situation.

The above system for media storage management can be readily constructed by those skilled in the art once provided with the algorithms described just above with reference to FIG. 4. This system allows for a flexible system where different media types are stored with different priority levels associated with different levels of redundancy to automatically adapt to the addition of new storage or the failure of existing storage without user intervention. The state of the art for redundant storage of media in such systems relies on storing all media on a single pair of on-board redundant disks using a standard RAID controller card to manage reliability or a stand alone off-board redundant disk device. Such systems lack the capabilities of the preferred embodiment of the invention.

In a particular embodiment the cable TV “set top” box illustrated in FIG. 1 as 1650 can be incorporated into the UMS as part of application 1040. In the case of the integration of the cable decoder function, the box count could be reduced from two to one.

In another particular embodiment, a satellite TV decoder box illustrated in FIG. 1 as 1650 can be incorporated into the UMS as part of application 1040, reducing the total box count from three to two, with the second box being typically a DSL data modem.

In both cases this action would be desirable to save on footprint and common equipment such as power supplies and chassis. The so-called “IR blaster” capability of 1550 would no longer be needed as a more reliable internal interface would exist. For the case of the cable set top box, the northbound network interface 1200 would be connected internally to 1650 via 1300, allowing for efficient usage of the data capabilities of the cable set top box. Finally, the integration of a cable set-top box would allow for the integration of the telephony module 1010 with cable telephony services.

In a particular embodiment, the UMS supports standards defined by an industry group called the Universal Plug and Play (UPnP) Forum. This group has defined a set of XML based standards for the interactions of media servers and DMRs. These standards cover functions such as device discovery, searching for particular media, requesting transfer of media, etc. If these standards are implemented as part of the UMS, the UMS will be able to interact with DMRs from a variety of vendors using the UPnP standards. Although support of the UPnP standards provides additional value for the customer, support of these standards is optional, and is not fundamental to the nature of the UMS/DMR system.

In another particular embodiment, the UMS supports standards defined by another industry group, the Digital Living Network Alliance (DLNA) which is in the process of creating a set of additional standards built on those of the UPnP Forum. These additional standards, which as of March 2005 are still in development, specify such things as a mandatory audio and video format, the protocol to be used for media transfer between the DMR and the UMS, etc. If these standards are implemented as part of the UMS/DMR system, the UMS will be able to interact with DMRs from a variety of vendors using the DLNA standards. Although support of the DLNA standards are expected to provide additional value for the customer, support of these standards is optional, and is not fundamental to the nature of the UMS/DMR system.

In a preferred embodiment value of the UMS to the customer can be enhanced by the addition of various entertainment related functions and devices. As illustrated in FIG. 3, the media manager 3851 performs the function of interfacing the PVR application to a variety of media sources 3805, 3810, 3815, 3820, 3825, 3830, 3835, and 3840. The media manager is responsible for delivering the media to the PVR application, which implements trick mode features such as PAUSE on the media stream. The media manager 3851 is also responsible for distributing media to the various DMRs 3125 and 3135 under the direction of commands from the various IR remotes 3875 and 3876 via the PVR application 3800 and the networking module 3020. In some cases, the incoming media may be stored in a compressed form on a disk via the connection between the media manager 3851 and the storage module 3030. Note that some forms of incoming video 3830, 3840, and 3825 must be encoded and compressed by the video encoder 3575. This video encoder 3575 in the preferred embodiment is a MPEG2 encoder but could be a MPEG4, H.264, or other video encoder in alternative implementations.

3805 is a standard compact disk (CD) drive.

3810 is a combined DVD/CD drive.

3815 is a combined DVD-R and CD R/W drive

3820 is a combined DVD-RW and CD R/W drive

3825 is a VHS tape drive.

3830 is an 8 MM video tape player such as is often used in camcorders.

3835 includes various media stick inputs. A typical current device can read seven different media sticks such as Compact Flash (CF), IBM Micro Drive, Multimedia Card (MMC), Secure Digital (SD), Memory Stick (MS), Memory Stick PRO, and Smart Media (SM).

3840 is a block of such standard video inputs as S-Video, Composite, high-definition television (HDTV), etc.

Although in FIG. 3 only a single combination TV tuner/IR “blaster” 3550 is illustrated, the PRV application 3800 can support multiple TV Tuner/IR blaster combinations. Specifically, two or more TV tuner/IR “blasters” combinations can be supported, with each controlling a different cable TV or satellite set top box. To support the simultaneous encoding of incoming video streams, corresponding multiple video encoders 3575 are required as well.

In the preferred embodiment to allow the UMS to record one television show while watching another on a locally attached TV, an RF pass-thru 3625 allows the complete, decoded video signal to reach both the local TV 3675 and the UMS TV Tuner module 3550. The output connection to the TV 3675 may be any of several standard video outputs, such as composite, progressive, S-Video, and HDTV. The RF pass-thru 3625 is such that in the event the UMS is turned off, the TV can be used normally.

In a particular embodiment the functionality of a DMR may be integrated with the UMS to allow for the rendering of pre-recorded or internet derived videos to a directly connected television monitor. Videos from the storage module 3030 are decrypted if need be in the digital transmission content protection (DTCP) module 3826, and than presented to the video output block 3855 by the PVR application 3800. An infra-red IR transceiver block 3860 receives signals from a local remote control device 3676 and forwards them to the PVR application 3800. A key requirement from holders of media copyrights is the ability of media playback equipment to protect media against illegal copying. This is achieved via the usage of various schemes for Digital Rights Management (DRM) to protect media between the source on the internet 3100 and the UMS itself. Within the UMS these DRM schemes are terminated in the Subscription Application 3815. The application 3815 supports a plurality of DRM schemes, some proprietary and some standardized. As the copyrighted material is distributed within the home, it is protected via encryption according to a standardized protocol such as DTCP in 3826. After distribution to the appropriate DRM 3125, DTCP is decrypted by 3490 and the media are displayed on the associated television 3880.

If copyrighted material is sourced from 3805, 3810, 3815, 3820, or 3835, the media manager 3851 directs the media to the DTCP encryptor 3826 as needed before distribution to the appropriate DRMs. Specifically, if the Video Encoder 3575 detects copy protection technology such as, for example, MacroVision, on the incoming video signal the PRV application 3800 can also cause the DTCP encryptor 3826 to add copy protection via DTCP before the encoder video is distributed to the appropriate DRMs.

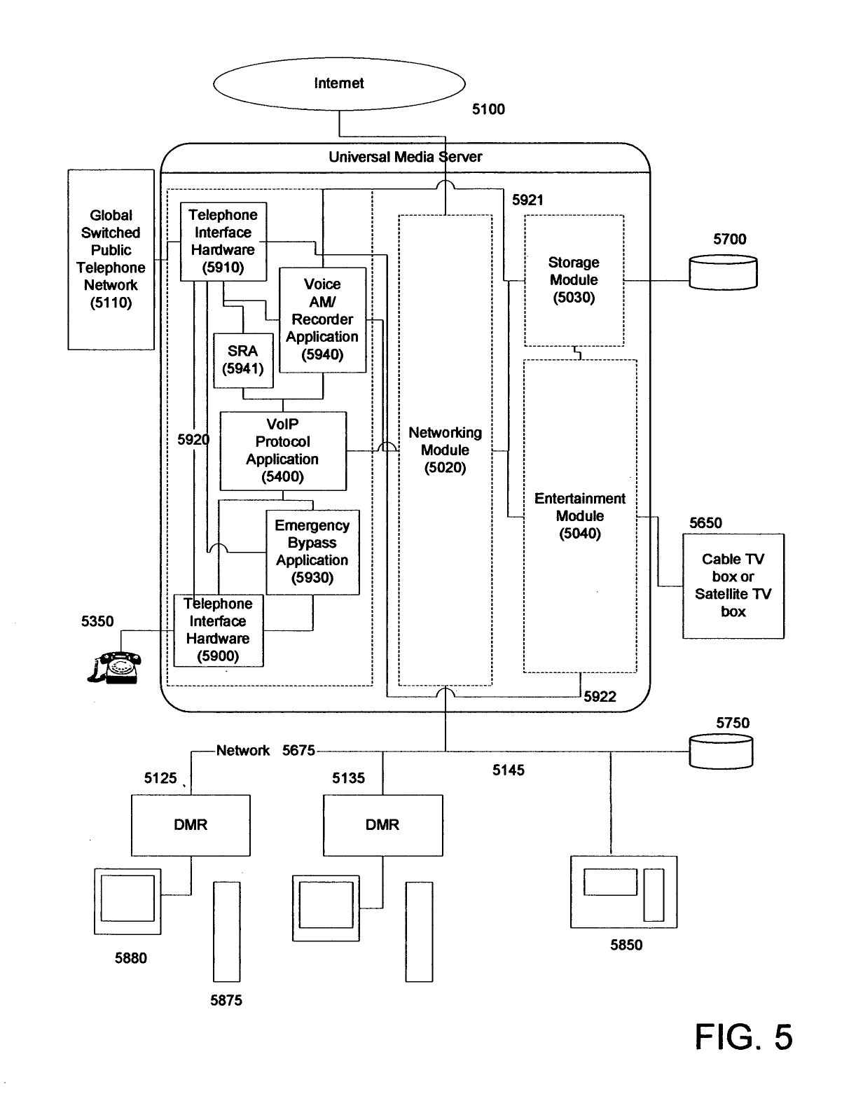

FIG. 5 illustrates various enhancements to the preferred embodiment of the UMS. A physical wire 5920 connects the telephone interface hardware 5900 that supports local legacy analog telephones 5350 to a northbound telephone interface 5910. When power fails to the device, a passive physical path exists between the phone 5350 and the legacy PSTN 5110, allowing for calls to be made although the UMS itself lacks power. If a plurality of hardware interfaces exist 5900, 5910 they can be wired in pairs to allow more than one phone 5350 to connect to the PSTN 5110 in event of power failure.

The emergency bypass application 5930 can be programmed by the user to recognize the dial strings associated with emergency calls, for example, 911. When these digits are dialed, either by the legacy analog phones 5350 or via a VoIP phone 5850, the application recognizes that the call is an emergency call, and routes it to the PSTN 5110 via 5910. This allows the user of the UMS to optionally avoid relying on potentially immature 911 services provided by VoIP service providers.

In the preferred embodiment a voice recorder/answering machine application 5940 is added to the UMS. In its answering machine mode, this application routes unanswered incoming calls whether from the PSTN 5110 or from VoIP phones on the internet 5100 to storage in 5030. The answering machine application also plays a welcome message retrieved from 5030. A wide range of functions are possible in this application, including multiple welcome messages, retrieval of messages from telephones remoted over either the PSTN 5110 or the internet 5100, retrieval of messages stored in 5030 using local phones 5350 or 5850, and retrieval of messages stored in 5030 via a DMR 5125 using an IR remote. One specific advantage of the UMS over the mere side-by-side association of an answering machine and a PVR is that the incoming PSTN voice calls that are directed to storage on “no answer” can be transported to the storage module 5030 over an internal connection 5921, with the result that bandwidth on the home network 5675 is not utilized for this purpose. The retrieval of voice messages using a DMR 5125 and an IR remote is an additional functionality that is realized by the combination of an answering machine in the UMS/DMR system. Another advantage of combining the answering machine function 5940 with the entertainment module 5040 and its associated storage module 5030 is that instead of separate, fixed storage units associated with the answering machine and the PVR/DVR, a single unified storage module 5030 can be flexibly allocated to each application. This has the effect of providing a much greater amount of storage than is typically found in answering machines, allowing for features such as the following to be provided: (1) thousands of long voice messages can be saved by the user for significant periods of time (months or years), with little need to delete any of them, (2) voice messages of great value can be so marked and stored redundantly, (3) if the VoIP protocol application supports putting a call on local hold while answering another call, the call on hold can be provided with music/video on hold using a rich array of audio and video materials, including but not limited to stored music, Internet Radio, etc., and (4) the existence of such a wide array of media to support music/video on hold features allows for caller-id based per-incoming-user customization of music on hold, where each of a person's friends might hear their favorite song, for example.

In a particular preferred embodiment a recorder mode of 5940 where the audio/video contents of a telephone or videophone call is stored locally via 5030. This mode is entered via the usage of touch tones entered via the keypad, for example, “*5”, or other such configurable strings of symbols. The mode may also be set up using the DMR IR controller 5875 for all calls from a particular incoming number, assuming caller id is available. Once voice calls have been recorded, they may be played back via the DMR 5125 using the remote control 5875 to make full usage of the PVR functions PAUSE, FAST FORWARD, etc. provided by the entertainment module 5540 as it processes the speech being retrieved from the storage module 5030. The use of the preferred embodiment of the UMS/DMR system allows for both direct access to a given recorded voice call, and also to any point within that call.

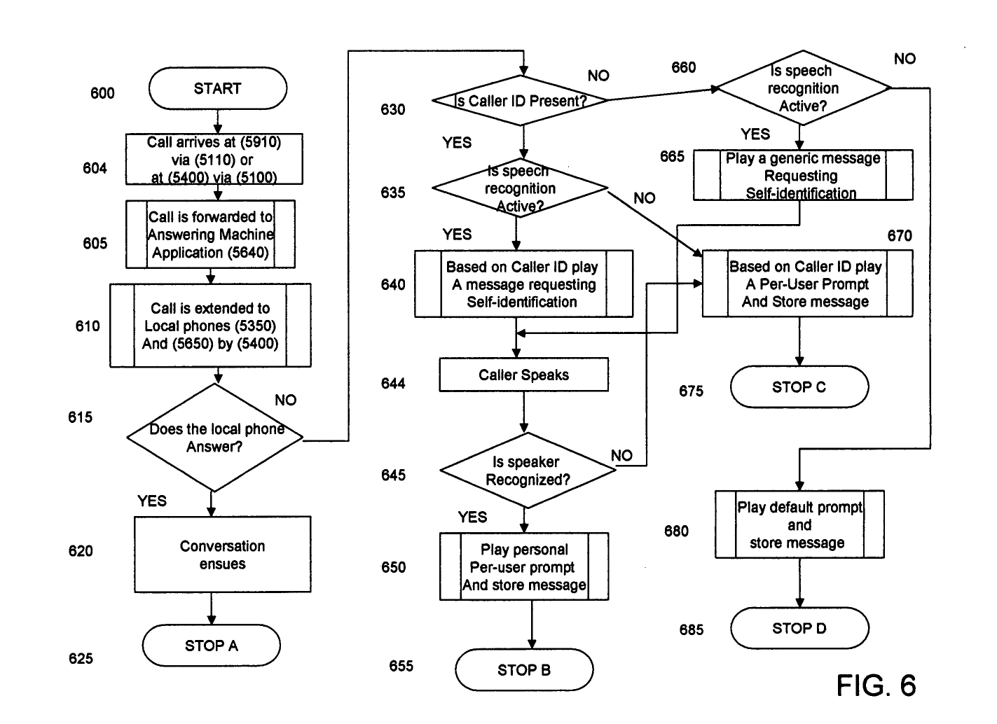

Another preferred embodiment allows the person watching television 5880 to use the remote control 5875 to select a menu choice or icon calling for “do not disturb.” This causes all incoming phone calls from either 5110 or 5100 to go directly to the storage module 5030 from the answering machine application 5940. When a call arrives, and while it is ringing, the caller is identified using the algorithm of FIG. 6, and a photo, if available, of the caller is displayed in a PIP window. The user can then, if they choose, answer the call. A preferred enhancement of this application prompts incoming callers for an over-ride password, which, if entered, causes the phone call to be presented normally to the home phones 5350, 5850 even though the “do not disturb” icon has been selected.

Another aspect of the preferred embodiment allows for customization of answering machine messages as illustrated in FIG. 6. With reference to FIG. 5, a call arrives either from the internet 5100 or the PSTN 5110 in step 604. If the incoming call is not answered by a human in step 615, the UMS checks to see if caller id information has been provided in step 630. Assuming that caller id information is present, the UMS moves to step 635, where it checks whether the speech recognition application 5941 is active. If this function is active, in step 640 the UMS uses the caller id information to select a customized message requesting self-identification, such as, for example, “Are you George Smith?” Note that although the caller id may indicate that the call is from a George Smith, there is no assurance that this is really the person calling. In step 645, the UMS uses standard speech recognition techniques well known to those versed in the art to confirm that in fact, this is George Smith. If the speech recognition module 5941 confirms that this is in fact George Smith, in step 650 a personal message, perhaps conveying information of vital importance, is used to prompt George to leave a message. If the speech recognition application 5941 does not confirm that this is George Smith a more general message such as “Welcome, user of George Smith's phone. Please leave a message at the beep” is played, and the caller's message is stored in step 670. Processing of this thread terminated in step 655 when the caller hangs up after the message is complete. A number of other possible sets of actions by the UMS are also illustrated by FIG. 6. The preferred embodiment implements all of these possible actions. In the preferred embodiment, the UMS may play previously stored messages, or may use text to speech capabilities to create speech prompts as needed.

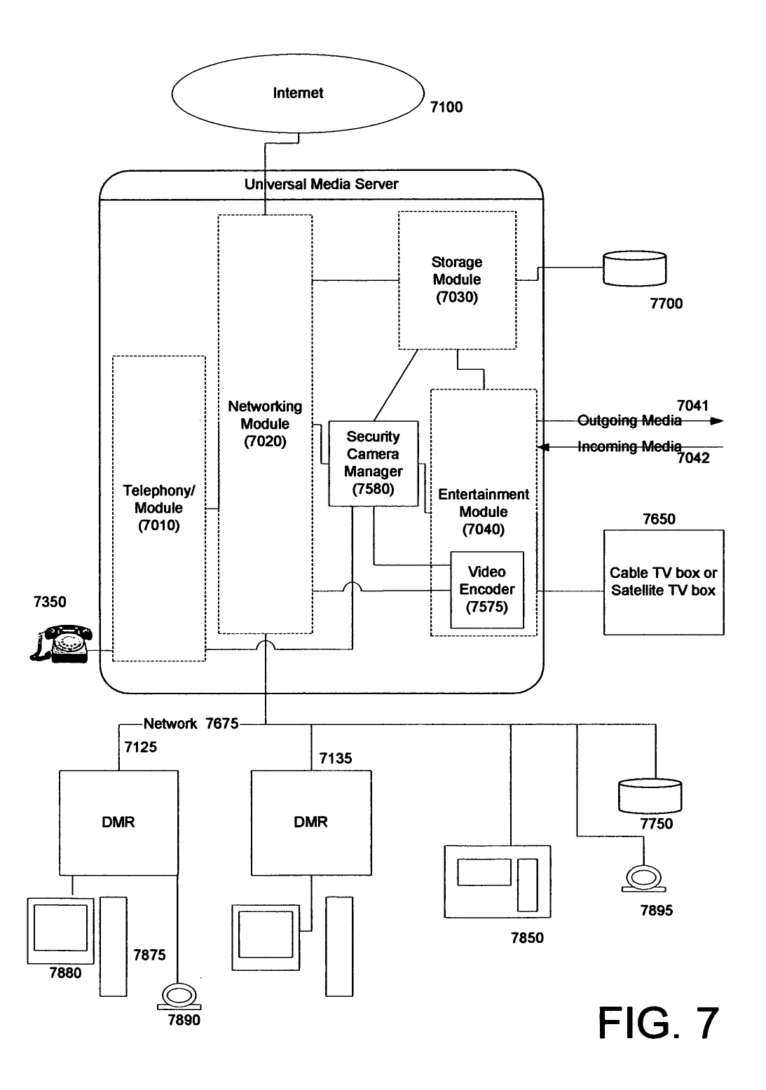

FIG. 7 illustrates a preferred embodiment of a UMS enhanced to provide a security monitoring function Video from a security camera 7890 attached to a DMR 7125 via a standard interface such as USB 2.0 or IEEE 1394 is encrypted by the video camera encoder using any of a plurality of standard video encoding techniques, including MPEG2, MPEG4, H.264, etc. This video is sent to the UMS via the in-home network 7675 and is routed to the security camera application 7580 by the routing module 7020. The security camera application 7580 is responsible for storing the video from a plurality of security cameras using the storage module 7030 for later retrieval. Note that both security cameras 7890 and 7895 have built-in microphones in the preferred embodiment.

In a variation on the preferred embodiment compressed video from a wired or preferably wireless security camera 7895 without a built-in encoder is sent to the video encoder application 7575 via the routing module 7020, which encodes the video using any of a plurality of standard video encoding techniques, including MPEG2, MPEG4, H.264, etc. The video is then sent to the security camera application 7580 for processing and storage in 7030.

Stored security videos can be retrieved from any DMR 7125, 7135, etc. under control of the appropriate IR remote for example, 7875 interacting with the security camera application 7580; this video is displayed on the television 7880 associated with the IR remote 7875 and the DMR 7125. In the preferred embodiment, multiple security camera images may be displayed simultaneously when the security camera application 7580 supplies a video mixing function. In a particular preferred embodiment, four camera outputs are mixed into a single image. A much larger number of security camera inputs can be surveyed via the display of thumbnail snapshots of each video stream being sampled on a single screen by the security camera application 7580. A function of the security camera application 7580 is to monitor incoming video streams, including their audio components. When 7580 detects motion in the video image using any of a plurality of standard techniques, and/or when the audio level associated with a particular camera rises above a certain user-configurable level, the image is automatically presented as a PIP on the TV screen 7880 to allow the user watching TV to assess the possible threat event. This added functionality is a direct result of the combination of a security monitoring system 7580 with the entertainment module 7040 in the context of a preferred UMS/DMR system.

With reference to FIG. 1, the advanced PVR functions of U.S. patent application Ser. No. ______ “Systems and Method for Enhanced Video and Audio Program Editing”, Skran, et al., Feb. 22, 2005, which are included herein by reference, are implemented in the preferred embodiment of the UMS in module 1800 with some user interface processing occurring in the DMR 1125, 1135, etc.

With further reference to FIG. 1, the system and method of constructing a media server/DMR system described in U.S. patent application Ser. No. ______ “Application Interface Streaming System and Method”, Aguilar, Feb. 28, 2005, included herein by reference, is implemented in the preferred embodiment of the UMS/DMR system to achieve various benefits, including but not limited to lower cost of goods, faster development time, and greater ease of software upgrades, as well as the major benefit of allowing a DMR to act as a remote PC console at little to no additional cost.

In a particular implementation of the preferred embodiment of the UMS, and with reference to FIG. 1, the entertainment application 1040 supports thumbnail channel surfing by category. The idea of “surfing” channels via the review of thumbnail images selected from a variety of video channels is part of the current art. However, in the preferred embodiment the concept of a “category” or “genre” is added so that as part of the user interface provided by 1040 for display on 1880, the user is allowed to, as part of selecting “Thumbnail channel surfing” to also select a category from a list of genres, including, for example Science Fiction, Westerns, Drama, Children, Anime, Action, Horror, Comedy, Soaps, Reality, Talk, News, and Romance. Once a category is selected, only thumbnails from channels matching the category will be displayed while thumbnail channel surfing.

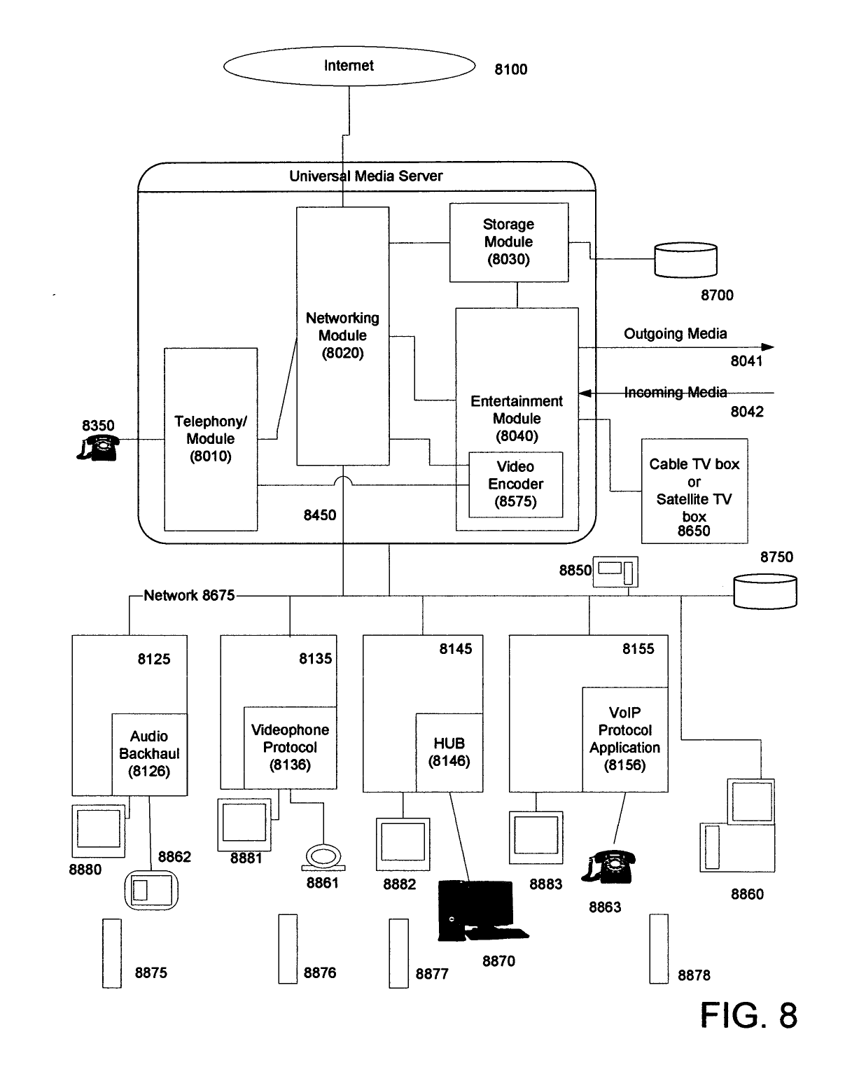

FIG. 8 illustrates certain enhancements to DMRs that increase the value of the preferred UMS/DMR system. DMR 8125 has been enhanced with an audio backhaul function 8126 and a standard RJ-11 analog telephone interface, shown here connected to a speakerphone 8862, although a standard analog phone such as 8350 could also be used. The audio backhaul module performs the following functions:

(1) Terminates the standard analog signaling from the RJ-11 interface

(2) Digitizes the analog audio stream to 16-bit digital samples at 64 KHz. In an alternative embodiment, a simple encoding such as G.711 mu-law might be used (8-bit samples at 64 KHz).

(3) Packetizes the digitized audio samples and the standard analog telephony signaling on-hook, etc. (4) Sends them to the UMS over 8125 and 8675 using a protocol such as real time protocol (RTP). Telephony signaling (button pushes, hook actions) are encoded using a simple protocol of the type/length (in octets, including type)/value format as follows:

Type=Digit(1), Length=3, Value=Digit[1-16, binary]

Type=Signal(2), Length=3, Value=OnHook[17]

Type=Signal(2), Length=3, Value=OffHook[18]

Type=Signal(3), Length=3, Value=Flash[19]

(5) At the UMS the audio/signaling stream is terminated by the Video/Voice over IP Protocol Application in the telephony module 8010 which is responsible for encoding the 16-bit audio stream in a standard audio encoding such as G.711, G.729A, G.728, etc. and originating the phone call to the network using standard VoIP protocols such as SIP, H.323, MGCP, etc. The general goal of this approach is to produce a very inexpensive DMR.

In another aspect of the preferred embodiment, DMR 8135 has been enhanced to support video over IP functions. Video (including audio) is collected by a standard USB2.0 web-camera 8861 and then encoded by 8136 into a standard video over IP protocol such as SIP or H.323, with the video encoded with a standard intended for real-time usage such as H.261, H.263, or H.264. The video over IP protocol stream is routed via 8675 to the telephony module 8010, which then is responsible for routing the call over the public internet, perhaps with the assistance of a network service. In an alternative embodiment, 8010 is not used, and the DMR interacts directly with a network service, the UMS appearing to be transparent.

A further aspect of this embodiment is that the DMR can be easily extended by those skilled in the art with the addition of a port (USB2.0, Ethernet, Firewire) for a security camera such as 8861, so that DMR 8135 operates in two modes (1) as a videophone and/or (2) as an interface for a security camera. In this latter mode, which might be settable via a physical switch on the DMR, or via configuration menus using the remote controller 8876, the audio/video stream is directed to the security module 8580 rather than the telephony module 8010. This type of DMR 8135 could be extended to support a plurality of videophone cameras and/or a plurality of security cameras.

In another variation on the preferred embodiment 8136 sends raw video/audio streams to the video encoder 8575 on the UMS, and then 8010 wraps the encoded video in a standard video over IP protocol such as SIP or H.323. This alternative allows for a less expensive DMR to be constructed, assuming the bandwidth of 8675 is sufficient to allow the raw video to be readily passed from the DMR to the UMS.

In a particular preferred embodiment, DMR 8145 has been enhanced to act as a data hub. The hub application module 8146 has one or more data ports, such as RJ-45 ethernet, USB 2.0, Firewire, etc. This module acts as a standard data hub or switch preferred, supporting communication with the networking module 8020. This enhancement allows DMR 8145 to be used to connect a PC 8870 to the internet using a wireless network 8675.

In another preferred embodiment, DMR 8155 has been enhanced to support VoIP protocols natively. In this DMR the VoIP protocol module 8156 implements standard VoIP protocols such as SIP, MGCP, or H.323. A standard analog telephone 8863 is attached via an RJ-11 interface. Thus, the DMR acts like a single-line VoIP gateway, and the UMS Voice/Video over IP protocol application inside the telephony module 8010 acts as one of a proxy (SIP), controller (MGCP), or a gatekeeper (H.323). In an alternative implementation, 8010 is not used, and the DMR interacts directly with a network service, the UMS appearing to be transparent.

In yet another variation on the preferred embodiment, 8860 is a standard videophone supporting a protocol such as H.323 or SIP. For such phones the Video/Voice over IP protocol application inside telephony module 8010 acts as either a gatekeeper or proxy respectively to allow the videophone 8860 to communicate with other video and audio telephones, both locally, on the internet, and on the PSTN.

As a result of the capabilities illustrated in FIG. 8, the preferred embodiment of the UMS/DMR system has a several additional aspects that extend beyond the current art for such systems. In one such aspect a local videophone user 8860 or 8861/8881 can be provided the capability of watching a variety of pre-recorded or live videos from the entertainment module 8040 while talking on the videophone to a remote party. This feature is presented to the user via an on-screen menu choice “SPECIAL MUTE” for 8861/8881, and via a “SPECIAL MUTE” button for videophone 8860. When this choice is selected, the user stops seeing the video from the far end and is provided a screen to allow for the selection of an alternative video source. This video source might be the output of one or more security cameras, which could be of great value if the customer is talking to the police. In the preferred embodiment the local videophone user may optionally configure a default video source that is displayed when the “SPECIAL MUTE” function is invoked, for example, a news channel such as CNN.

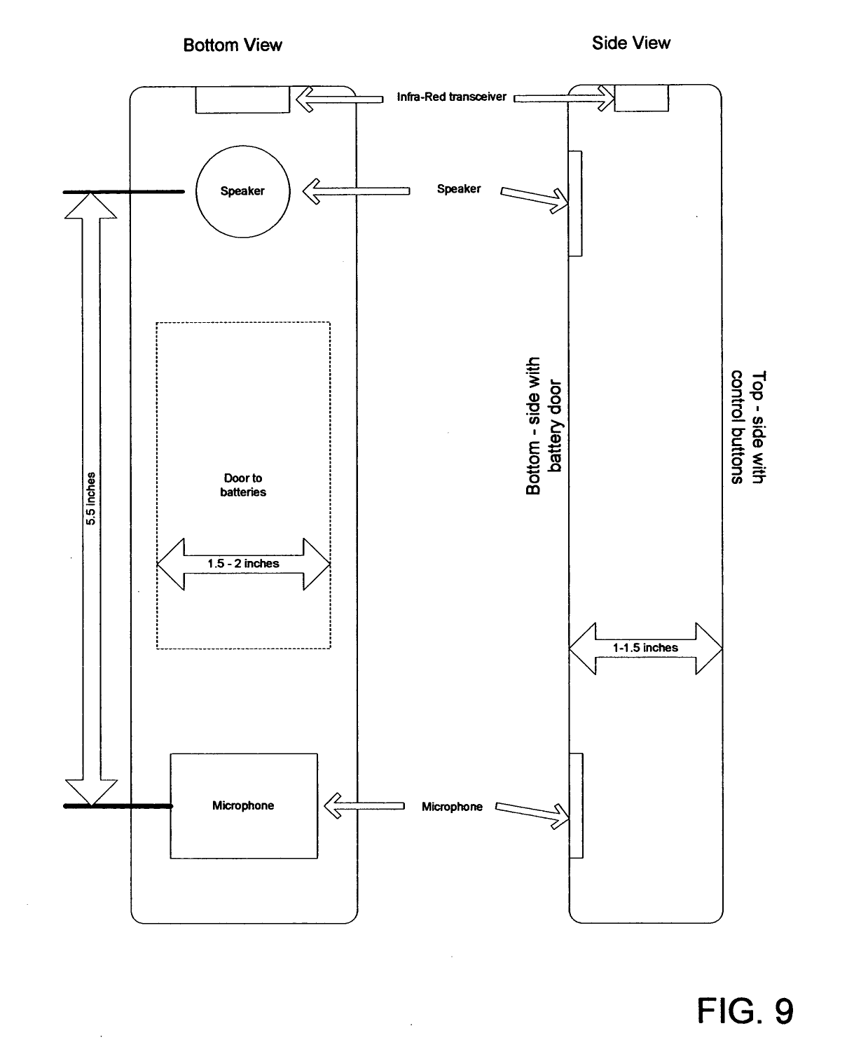

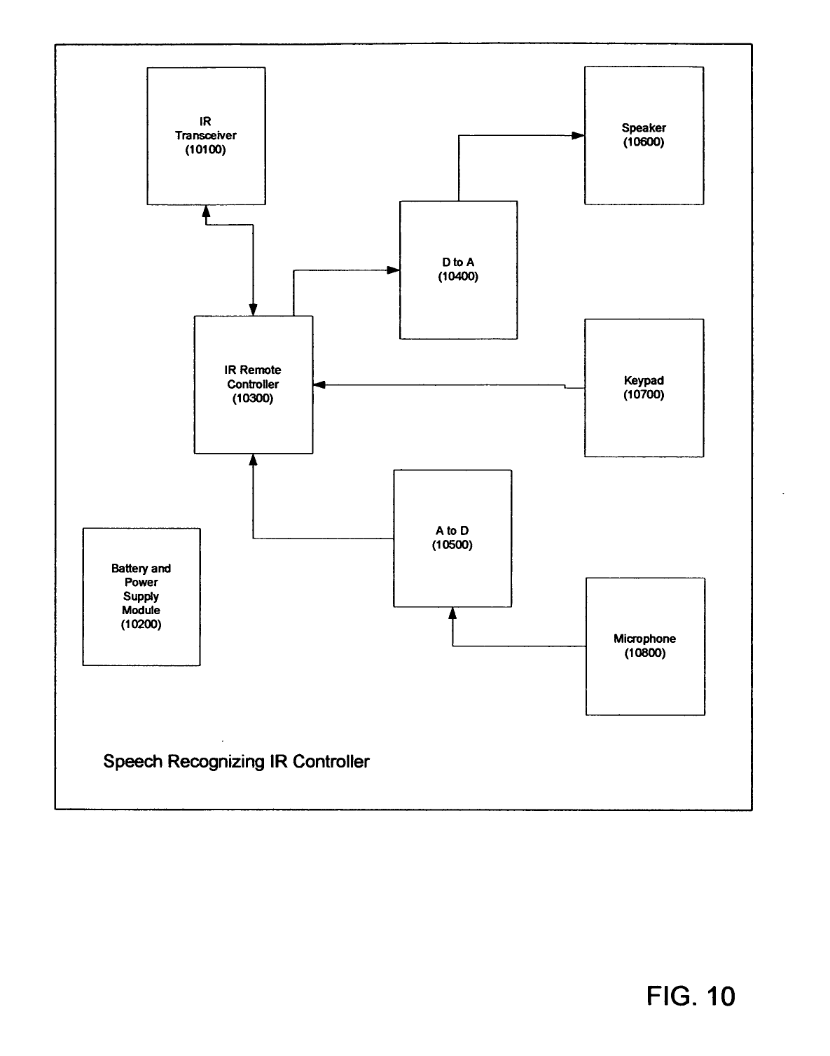

In the preferred embodiment of the UMS/DMR system speech recognition capabilities are added to the system without increasing the cost of the remote control or DMRs significantly. This is accomplished via adding a telephone-type speaker and microphone to the IR controller as illustrated in FIG. 9 and FIG. 10. As shown in FIG. 9, the speaker and microphone are physically far apart to achieve telephone-set levels of acoustic separation. Assume that with reference to FIG. 1, DMR 1125, IR remote 1875, and telephony module 1010 have been enhanced with the preferred speech recognition capabilities. First, the IR remote 1875 encodes the audio signal as G.711 mu-law. The encoded audio is sent to the DMR 1125 using the IR transceiver link. In the preferred implementation, a high-speed IR transceiver is used. The DMR 1125 sends the G.711 audio stream to the UMS over the in-home network 1675 where it is received by the speech recognition application of the telephony module 1010. Speech recognition is accomplished at the UMS using any of a plurality of standard techniques well known to those versed in the art.

Consider now FIG. 10 which shows the internal structure of the speech recognizing remote control. The blocks are as follows:

10100 is an IR transceiver such as the Agilent HSDL-3210-021 which allows two-way infra-red communication with the UMS. In the preferred embodiment a transceiver with a bit rate significantly higher than 64 Kbs will be used. The part suggested above supports data rates from 9.6 kbs to 1.15 Mbs.

10300 is a micro-controller such as the Intel 8051. Its functions include (1) collecting keypad presses and sending them to the UMS via 10100, (2) [in some embodiments] receive speech responses in G.711 format from the UMS via 10100 and send them to 10400, and (3) receive speech inputs from 10500, encode them to G.711, and transmit them to the UMS via 10100.

10500 is an Analog to Digital (A to D) converter

10800 is a microphone

10400 is a Digital to Analog (D to A) converter

10600 is a speaker

All of the above functions and components are standard and with the description above a person skilled in the art can construct the speech recognizing IR controller illustrated in FIGS. 9 and 10. The placement of the speech recognition processing on the UMS allows for the creation of an inexpensive and yet highly capable speech-control IR remote relative to current state of the art where speech recognition occurs in the remote itself, resulting in a more costly remote with limited speech recognition capabilities.

At various points in this patent application, reference is made as to how a remote control using speech recognition is part of the preferred embodiment. This speech-recognition remote can also be used generally to select menu items displayed by the UMS on the TV screen 1880 or by using methods of U.S. patent application Ser. No. ______ “Application Interface Streaming System and Method”, Aguilar, Feb. 28, 2005, included herein by reference, to interact with standard PC applications.

The preferred embodiment of the UMS provides a system and method which allows for suddenly “active” video channels to appear in a PIP, interrupting another video that is currently being viewed. This application applies to both entertainment video streams and security camera video streams, and also to video streams containing images generated by arbitrary PC applications. The steps involved are as follows with reference to FIG. 1:

STEP ONE: Using the IR remote 1875 and the user interface displayed on the TV screen 1880 by the entertainment module 1040, the user first selects one or more channels of interest.

STEP TWO: For each channel of interest, the user then selects at least one and potentially all of the following trigger categories from an on-screen menu:

TRIGGER ONE: Audio level: If the audio level rises above a user-set level, the channel will be put into the PIP window.

TRIGGER TWO: Audio Spike: On/Off—if on, the UMS continuously averages the audio level. If a spike occurs with a greater than X % (25% is the default) increase in volume over the moving average, the channel will be put into the PIP window. The value of X is user configurable.

TRIGGER THREE: Key Words—a list of key words is entered by the user. If the UMS speech recognizer detects any of these words, the channel will be put into the PIP window. The keywords are entered using the letter keys on the IR remote, via a keyboard directly attached to the UMS, via the remote web browser based management system or via a speech recognition remote control. Logical connections (AND, OR, NOT) and parentheses can be used to create more complex search expressions. Setting up these more complex structures requires the usage of the remote web browser interface, a direct interface to the UMS, or the speech recognition remote control.

TRIGGER FOUR: Motion—On/Off—if on, the UMS continuously runs a motion detecting algorithm well known-to those skilled in the art on the video signal. If motion is detected, the channel will be put into the PIP window.

STEP FOUR: The IR remote 1875 has a button that allows switching the video stream between the main window and the PIP window. In an alternative embodiment this may be accomplished via the selection of a menu choice using the IR remote. Once the automatically selected channel appears in the larger window, the full PVR functions provided by the entertainment module 1040 can be applied to that window.

STEP FIVE: The entertainment module 1040 saves a configurable amount of video (fault of 2 minutes) for each channel in a buffer. When activity is detected, and the channel has been moved from PIP mode to full-screen, the user is able to press buttons such as PAUSE, REWIND, etc. to find items of interest in the video stream that may have happened in the past, up to the limit of the configurable buffer.

1. A digital media recorder comprising:
an input for receiving media streams;
at least two storage devices for storing the received media streams;
a processor for providing redundant storage of the received streams in the storage devices;
an output for connecting to a device capable of rendering the media streams; and
a means for specifying user preferences for storing the received media streams in the storage devices.

2. The digital media recorder of claim 1, wherein user preferences for storing the received media streams comprise one or more of: (i) storage priority; (ii) level of redundancy; and (iii) access privileges.

3. The digital media recorder of claim 1, wherein at least two storage devices are in the digital media recorder's chassis.

4. The digital media recorder of claim 1, wherein media streams are received over a telephone line.

5. The digital media recorder of claim 4, wherein stored media streams include voice-mail messages.

6. The digital media recorder of claim 5 further comprising means for customizing storage preferences of a received media stream based on a caller ID number.

7. The digital media recorder of claim 6 further comprising means for displaying a message on an output device when a phone call is received.

8. The digital media recorder of claim 6 further comprising means for displaying an image on an output device when a phone call is received.

9. The digital media recorder of claim 1, wherein media streams are received from a video camera

10. The digital media recorder of claim 9 further comprising means for sending a media stream received from a video camera to an output device when the video camera detects motion.

11. The digital media recorder of claim 1, wherein the processor is connected to the storage devices over a computer network.

12. The digital media recorder of claim 11, wherein the computer network is the Internet.

13. The digital media recorder of claim 1 further comprising a remote control device operated by human voice commands.

14. The digital media recorder of claim 13 further comprising means for processing human voice commands.

15. The digital media recorder of claim 11, wherein the device capable of rendering the media is connected to the digital media recorder over the computer network

16. The digital media recorder of claim 15, wherein the device capable of rendering media comprises a networking hub.

17. The digital media recorder claim 15, wherein the device capable of rendering media comprises a videophone.

18. The digital media recorder of claim 15, wherein the device capable of rendering media comprises a voice over internet protocol telephone.
